(19) United States
(12) Patent Application Publication
(10) Pub. No.: US 2017/0162079 A1
(43) Pub. Date: Jun. 8, 2017

(54) Audio and Visual Enhanced Patient Simulating Mannequin

(71) Applicant: Adam Helybely, Budapest (HU)

(72) Inventor: Adam Helybely, Budapest (HU)

(21) Appl. No.: 15/369,671

(22) Filed: Dec. 5, 2016

Related U.S. Application Data
(60) Provisional application No. 62/262,543, filed on Dec. 3, 2015.

(51) Int. Cl. G09B 23/32; G09B 9/00; G09B 5/00

(52) U.S. Cl. CPC G09B 23/32; G09B 5/00; G09B 9/00

(57) ABSTRACT

An audio and visual enhanced patient simulating mannequin allows a medical practitioner to practice medical procedures to be applied when assessing an ailment for a patient. The simulating mannequin includes a plurality of sensors, a video input device, an audio input device, at least one audio output device, and a central processing unit (CPU). The plurality of sensors, the video input device, and the audio input device monitor the medical practitioner's interaction with the mannequin housing for the assessment of a simulated ailment. The at least one audio output device provides feedback for the simulated ailment for the medical practitioner to use for assessing the simulated ailment. The CPU processes the outputs from the plurality of sensors through an ailment simulation algorithm in order to determine the feedback output by the at least one audio output device.

The current application claims a priority to the U.S. Provisional Patent application Ser. No. 62/262,543 filed on Dec. 3, 2015. The current application is filed on Dec. 5, 2016 while Dec. 3, 2016 was on a weekend.

### FIELD OF THE INVENTION

The present invention relates generally to an interactive patient simulating mannequin. More specifically, the present invention is an interactive patient simulator incorporating audiovisual functionality and remote controllability for medical professionals to practice procedures.

### BACKGROUND OF THE INVENTION

There are many jobs in the medical field that require specific training so that patients receive the most effective and efficient response. One common aspect of each job in the medical field is patient care. This, however, is typically an aspect of the medical field that is learned through experience. Instead of having actual patients experience the trial and error of learners, the present invention allows medical practitioners to safely practice patient care on patient simulators.

The present invention is an audio and visual enhanced patient simulating mannequin for the purpose of teaching patient care through a more realistic patient simulation by enabling medical practitioners to interact through audio and visual (AV) input devices. The AV input devices are built into a patient simulator which is preferably a mannequin. From audio and visual inputs, the patient simulator analyzes and responds to the sounds captured by an internal microphone and the images captured by an internal camera in order to provide auditory and motor responses from the actions of the medical practitioners. The responses of the patient simulator may be automatic or manually controlled by a facilitator. The responsiveness of the present invention provides medical practitioners with a fully immersed learning environment.

Medical practitioners interact with the present invention not only with traditional actuators and sensors, but also with simulation software on an external computing device and the AV input devices of the simulator. The outputs of the traditional actuators, sensors, simulation software, and AV input devices are transferred to the facilitator's workstation.

### BRIEF DESCRIPTION OF THE DRAWINGS

FIG. 1 is a schematic diagram of the present invention.

FIG. 2 is a schematic diagram of the present invention detailing a plurality of stethoscope placement sensors, wherein the plurality of stethoscope placement sensors is located at cardiac sites of the mannequin housing.

FIG. 3 is a schematic diagram of the present invention detailing the plurality of stethoscope placement sensors, wherein the plurality of stethoscope placement sensors is located at respiratory sites of the mannequin housing.

FIG. 4 is a schematic diagram of the present invention detailing a plurality of intubation positioning sensors, wherein the plurality of stethoscope placement sensors is positioned along a throat tube.

FIG. 5 is a schematic diagram of the present invention detailing a plurality of anatomical actuators.

FIG. 6 is a schematic diagram of the present invention detailing a plurality of permeable membranes and a plurality of positional sensors.

### DETAIL DESCRIPTIONS OF THE INVENTION

All illustrations of the drawings are for the purpose of describing selected versions of the present invention and are not intended to limit the scope of the present invention.

The present invention is an audio and video enhanced patient simulating mannequin. The present invention allows a medical practitioner to practice performing medical procedures to prepare the medical practitioner to perform the procedure on a living patient. The medical practitioner interacts with the present invention as they would with a patient and receives auditory responses from the present invention. From the auditory responses, the medical practitioner is able to proceed with the procedure and assess a simulated ailment for the patient that the medical practitioner may encounter in the future.

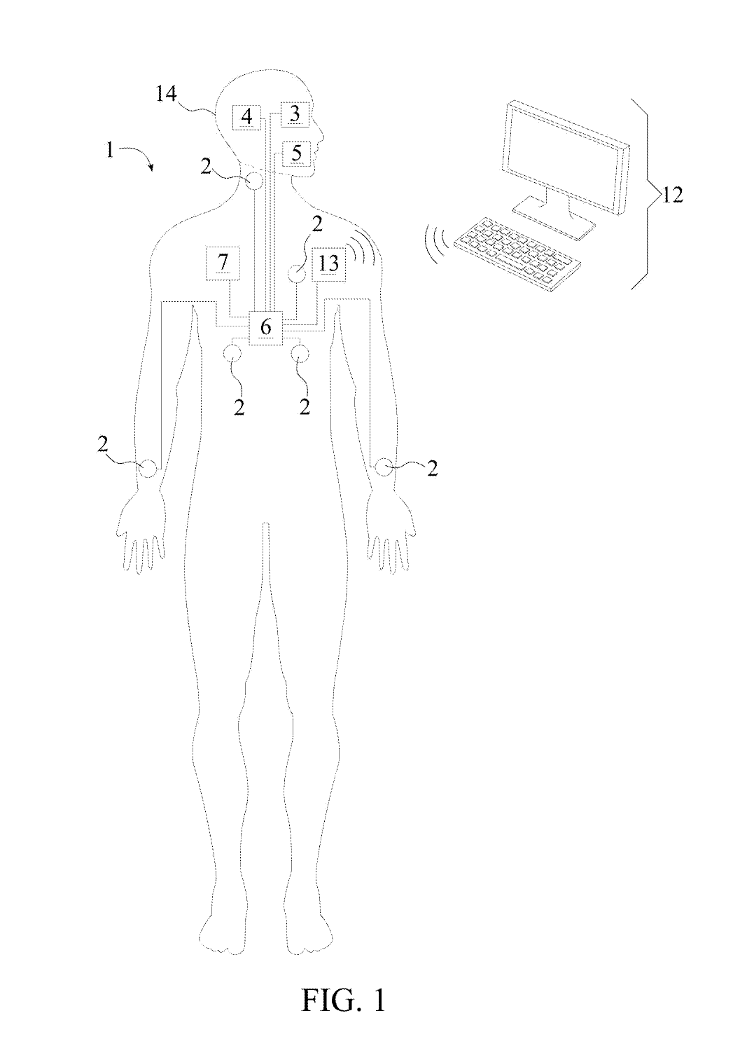

In accordance to FIG. 1, the present invention comprises a mannequin housing 1, a plurality of sensors 2, a video input device 3, an audio input device 4, at least one audio output device 5 and a central processing unit (CPU) 6. The mannequin housing 1 imitates the form of a human to allow the medical practitioner to gain familiarity with relative anatomy. The plurality of sensors 2 detect the medical practitioner's interaction with the mannequin housing 1 for the assessment of the interaction. The video input device 3 records the medical practitioner's interaction for the medical practitioner or a third party to examine and assess the medical practitioner's interaction with the present invention. The audio input device 4 records external audio sounds surrounding the mannequin housing 1, such as the medical practitioner's voice to be processed through voice recognition software for assessment of the simulated ailment, as well as, recording audio for the assessment of the medical practitioner's bedside manner. The at least one audio output device 5 emits auditory responses to the medical practitioner for the symptoms of the simulated ailment. The plurality of sensors 2, the video input device 3, the audio input device 4, and the at least one audio output device 5 are mounted within the mannequin housing 1. The plurality of sensors 2 is distributed throughout the mannequin housing 1 in order to assess the medical practitioner's interaction with the mannequin housing 1 adjacent to a sensor of the plurality of sensors 2. In accordance to the preferred embodiment, the video input device 3 is positioned within a head 14 of the mannequin housing 1, such that the video input device 3 allows for the recording of the medical practitioner's interactions from the point of view of the patient. The plurality of sensors 2, the video input device 3, the audio input device 4, and the at least one audio output device 5 are electronically connected to the CPU 6, such that the CPU 6 is able to process the input and output of electronic signals to and from the plurality of sensors 2, the video input device 3, the audio input device 4, and the at least one audio output device 5.

Further in accordance to the preferred embodiment of the present invention, the present invention comprises a memory storage device 7, as show in FIG. 1. The memory storage device 7 allows for the retention of ailment simulation algorithms, voice recognition software and audio response data. The aliment simulation algorithms provide a series of conditions for the medical practitioner to diagnose. The aliment simulation algorithms receive inputs from each of the plurality of sensors 2 and the voice recognition software to determine a response output from the audio response data to transmit to the at least one audio output device 5. The memory storage device 7 is internally mounted within the mannequin housing 1. The memory storage device 7 is electronically connected to the CPU 6. Therefore, auditory inputs from the audio input device 4 are able to be processed by the voice recognition software in order to determine a string of words spoken by the medical practitioner. The string of words is input into the aliment simulation algorithm in order to determine the response output from the audio response data. The response output is then sent to an audio output device of the at least one audio output device 5 such that the response output is audibly emitted to be heard by the medical practitioner for the assessment of the simulated ailment.

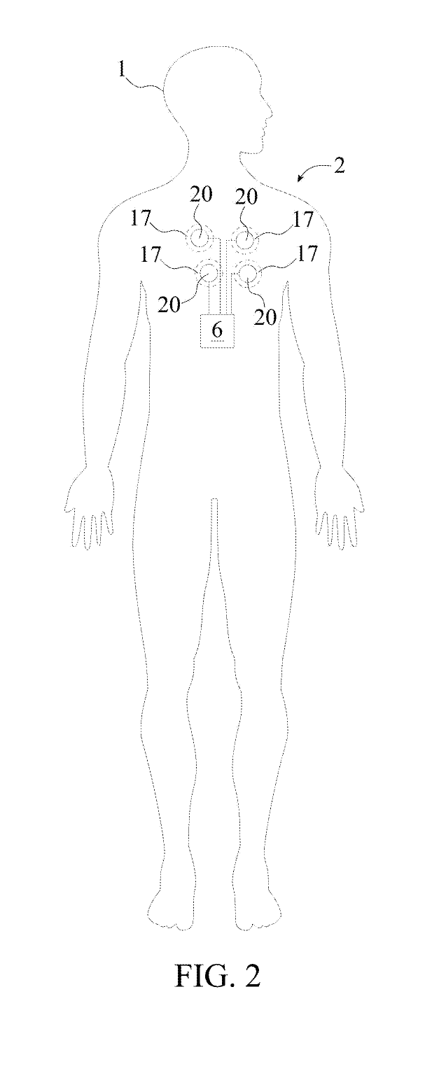

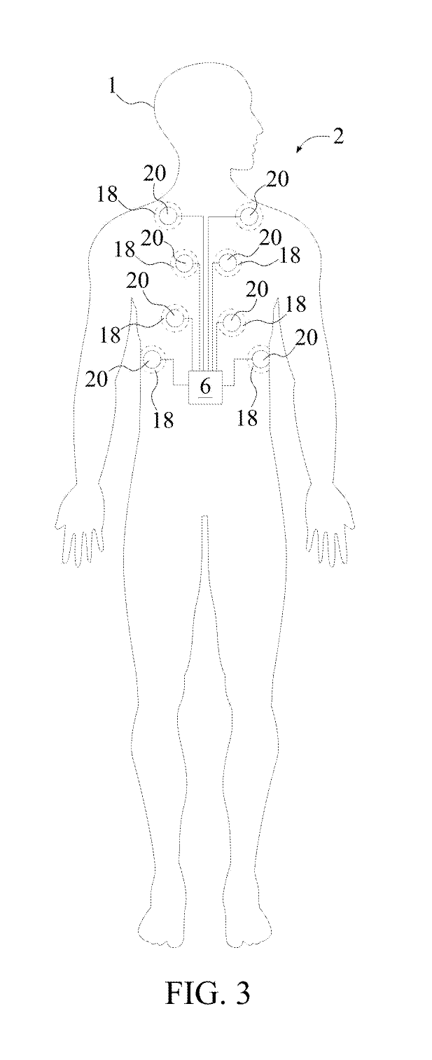

For further assessment of the simulated ailment, the preferred embodiment of the plurality of sensors 2 comprises a plurality of stethoscope placement sensors 20, as shown in FIG. 2 and FIG. 3. The plurality of stethoscope placement sensors 20 assesses the placement of a stethoscope by the medical practitioner on the mannequin housing 1. The plurality of stethoscope placement sensors 20 include, but is not limited to, pressure sensors and radio-frequency identification (RFID) sensors to indicate the proximity of the stethoscope to the target location. The plurality of stethoscope placement sensors 20 is positioned within a torso 16 of the mannequin housing 1. For one embodiment of the plurality of stethoscope placement sensors 20, each stethoscope placement sensor is positioned at a corresponding cardiac site 17 of the mannequin housing 1, shown in FIG. 2. This configuration allows the medical practitioner is able to practice placing the stethoscope for auscultation of the heart, veins, and arteries. In another embodiment of the plurality of stethoscope placement sensors 20, each stethoscope placement sensor is positioned at a corresponding respiratory site 18 of the mannequin housing 1, shown in FIG. 3. This configuration allows the medical practitioner is able to practice placing the stethoscope for auscultation of the lungs and bronchial tubes.

In some embodiments of the present invention, the present invention comprises an external audio output device is adjacently connected to a stethoscope or a mock stethoscope device the medical practitioner uses to practice stethoscope placement. The external audio output device emits a heartbeat or breath sound from the audio response data as the stethoscope sensor is activated for the respective embodiment of the present invention. The external audio output device is activated as a RFID tag mounted to the stethoscope or mock stethoscope is positioned adjacent to a stethoscope placement sensor of the plurality of stethoscope placement sensors 20.

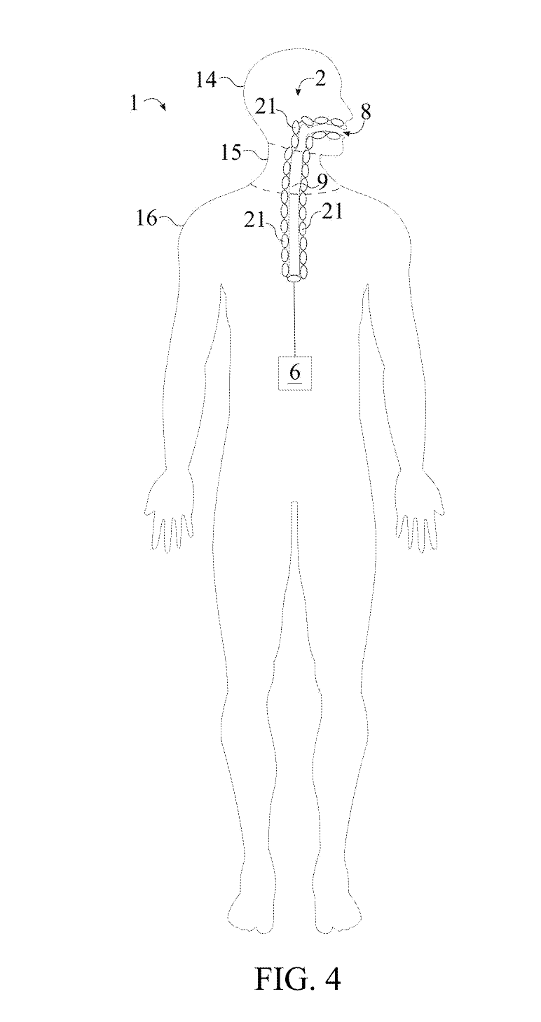

In accordance to another embodiment of the present invention, the present invention comprises a mouth opening 8 and a throat tube 9 for the medical practitioner to practice intubation procedures, as shown in FIG. 4. The plurality of sensors 2 comprises a plurality of intubation positioning sensors 21 to assess the insertion of an intubation tube. The mouth opening 8 traverses into the head 14 of the mannequin housing 1 to mimic a mouth of a patient. The throat tube 9 is positioned within a neck 15 of the mannequin housing 1. The mouth opening 8 is coupled with the throat tube 9 in order to allow an intubation tube to be inserted through the mouth opening 8 and into the throat tube 9. The plurality of intubation positioning sensors 21 is adjacently positioned about the mouth opening 8 and along the throat tube 9. Thus, the progress of the insertion for an incubation tube is able to be monitored from the output from the plurality of intubation positioning sensors 21. The plurality of intubation positioning sensors 21 includes, but is not limited to pressure sensors and RFID sensors to indicate the position of the intubation tube within the mouth opening 8 and the throat tube 9. Pressure sensors allow the medical practitioner to learn how much force to place on the tube during the intubation process to prevent possible injury for a future patient.

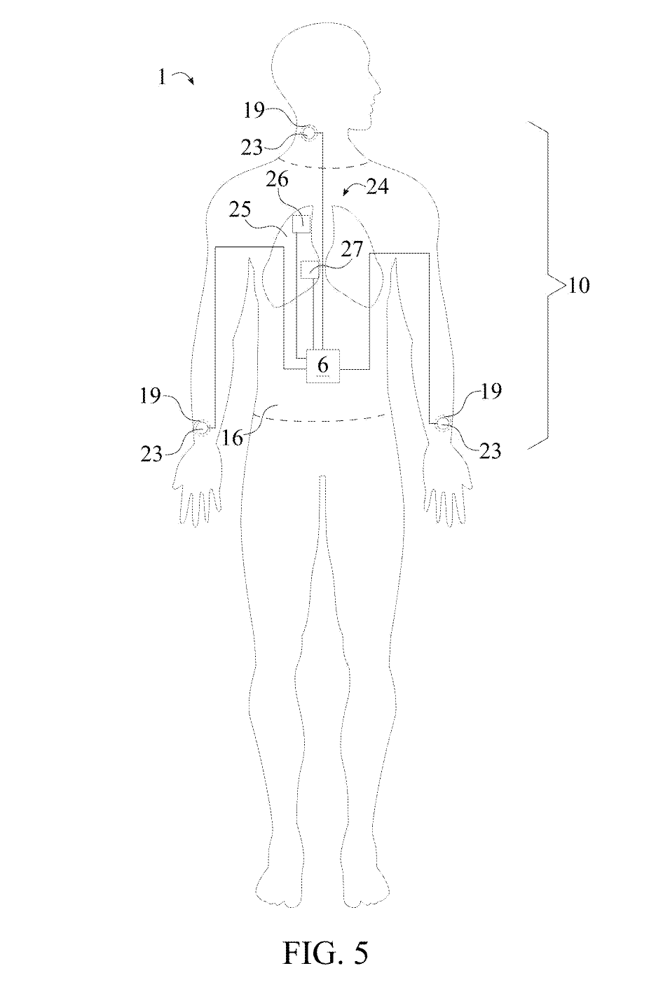

Further in accordance to the preferred embodiment of the present invention, the present invention comprises a plurality of anatomical actuators 10, detailed in FIG. 5. The plurality of anatomical actuators 10 is internally mounted within the mannequin housing 1 to simulate responses and functions of a human body which are reflexive or autonomic. The plurality of anatomical actuators 10 is electronically connected to the CPU 6 in order to receive an input from a motion output from the ailment simulation algorithm.

For some embodiments of the plurality of anatomical actuators 10, the plurality of anatomical actuators 10 comprises a plurality of pulsing actuators 23, shown in FIG. 5. The plurality of pulsing actuators 23 simulates a pulse for the medical practitioner to identify arterial pulse locations of a patient. Each of the plurality of pulsing actuators 23 is positioned at a corresponding arterial pulse site 19 in order for the medical practitioner to learn the location and assess the pulse rate and pressure at each arterial pulse site 19. The aliment simulation algorithm outputs the frequency and intensity for each of the plurality of pulsing actuators 23 through the CPU 6.

In accordance to another embodiment of the present invention, the plurality of anatomical actuators 10 comprises a pair of actuatable lungs 24, detailed in FIG. 5. The pair of actuatable lungs 24 simulate the breathing pattern of the patient for the medical practitioner to learn audio queues for symptoms of possible ailments, such as irregular breathing. The pair of actuatable lungs 24 being positioned within a torso 16 of the mannequin housing 1. More specifically, each of the pair of actuatable lungs 24 comprises an inflatable air bladder 25, a pressure release valve 26 and an air compressor 27. The inflatable air bladder 25 simulates the patient's lung. The pressure release valve 26 simulates the relaxation of the diaphragm to release air from the inflatable air bladder 25. The pressure release valve 26 is adjacently connected to the inflatable air bladder 25. The air compressor 27 simulates the contractions of the diaphragm to fill the inflatable air bladder 25 with air. The patient's breathing is simulated by filling and expelling air from the inflatable air bladder 25 from the air compressor 27 and out from the pressure release valve 26, respectively, as air compressor 27 is in fluid communication with the pressure release valve 26 through the inflatable air bladder 25. The pressure release valve 26 and the air compressor 27 are electronically connected to the CPU 6, such that the aliment simulation algorithm outputs control signals to the pressure release valve 26 and the air compressor 27 through the CPU 6. In some embodiments of the present invention, control signals are sent to the pressure release valve 26 and the air compressor 27 through the ailment simulation algorithm to indicate a successful intubation by filling the inflatable air bladder 25 or and expelling air from the inflatable air bladder 25.

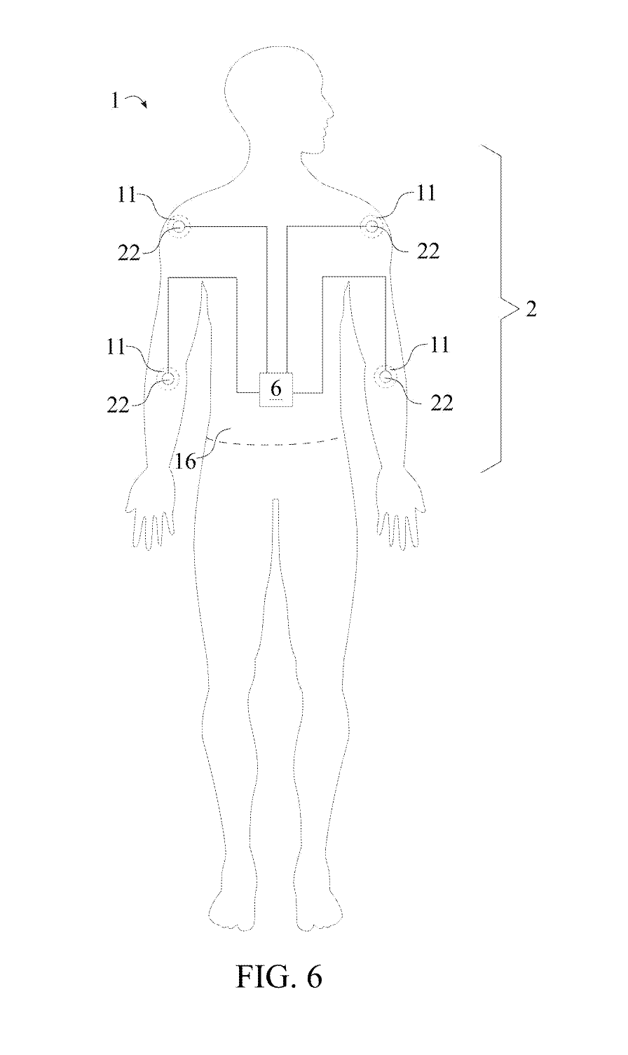

In still another embodiment of the present invention, the present invention comprises a plurality of permeable membranes 11 and a plurality of positioning sensors 22, as shown in FIG. 6, in order for the medical practitioner to practice needle insertions. The plurality of permeable membranes 11 is externally integrated into the mannequin housing 1 to allow a needle to penetrate a permeable membrane of the plurality of permeable membranes 11 to simulate the insertion of a needle into a patient's skin. The plurality of positioning sensors 22 measure the position and angle for an inserted needle through the permeable membrane in order to assess the technique and accuracy of the medical practitioner. The plurality of positional sensors 22 is mounted within the mannequin housing 1. Each of the plurality of positional sensors 22 is adjacently positioned to a corresponding permeable membrane of the plurality of permeable membranes 11 in order to measure positional data and angular data to be processed as an input to the ailment simulation algorithm with the CPU 6. The ailment simulation algorithm returns an audible output from the audio response data to indicate positive or negative feedback to the medical practitioner.

In accordance to the preferred embodiment of the present invention, the present invention comprises at least one external computing device 12 to send and receive progress information, ailment simulation algorithms, and sound files to and from the memory storage device 7. The at least one external computing device 12 includes but is not limited to personal computers, laptops, smartphones, or any other appropriate device. In accordance to FIG. 1, the CPU 6 is communicatively coupled with the at least one external computing device 12 to process information between the memory storage device 7 and the at least one external computing device 12.

In more specific embodiments of the at least one external computing device 12, the at least one external computing device 12 comprises a testing computing device and a moderator computing device. The testing computing device is a computing device the medical practitioner accesses to initiate or terminate the ailment simulation algorithm for practice assessment of a patient. The moderator computing device allows a test moderator to view the progress of the medical practitioner, to view the behavior and mannerisms of the medical practitioner through the video input device 3, to adjust parameters of the ailment simulation algorithm, or to initiate auditory responses for the medical practitioner to take into consideration when assessing the simulated ailment. In some embodiments of the present invention, the ailment simulation algorithm is stored on the testing computer, where outputs from the plurality of sensors 2 and the at least one audio output device 5, as well as, inputs for the plurality of actuators are communicated between the testing computing device and the CPU 6.

In some embodiments of the present invention, the present invention comprises a wireless transceiver 13 to conveniently communicate data to the at least one external computing device 12. The wireless transceiver 13 includes but is not limited to Bluetooth, Wi-Fi, or appropriate wireless technologies to send and receive data to the at least one external computing device 12, in accordance to FIG. 1. The wireless transceiver 13 is mounted within the mannequin housing 1 and the wireless transceiver 13 is electronically connected to the CPU 6. This configuration allows data to be conveniently transferred to the at least one external computing device 12, as well as, allowing the present invention to be conveniently transported.

Although the invention has been explained in relation to its preferred embodiment, it is to be understood that many other possible modifications and variations can be made without departing from the spirit and scope of the invention as hereinafter claimed.

What is claimed is:

1. An audio and video enhanced patient simulating mannequin comprises:
a mannequin housing;
a plurality of sensors;
a video input device;
an audio input device;
at least one audio output device;
a central processing unit (CPU);
the plurality of sensors, the audio input device, the at least one audio output device, and the video input device being mounted within the mannequin housing;
the plurality of sensors being distributed throughout the mannequin housing; and
the plurality of sensors, the video input device, the audio input device, and the at least one audio output device being electronically connected to the CPU.

2. The audio and video enhanced patient simulating mannequin, as claimed in claim 1, comprises:
the video input device being positioned within a head of the mannequin housing.

3. The audio and video enhanced patient simulating mannequin, as claimed in claim 1, comprises:
a memory storage device;
the memory storage device being internally mounted within the mannequin housing; and
the memory storage device being electronically connected to the CPU.

4. The audio and video enhanced patient simulating mannequin, as claimed in claim 1, comprises:
the plurality of sensors comprises a plurality of stethoscope placement sensors;
the plurality of stethoscope placement sensors being positioned within a torso of the mannequin housing; and
each of the plurality of stethoscope placement sensors being positioned at a corresponding cardiac site of the mannequin housing.

5. The audio and video enhanced patient simulating mannequin, as claimed in claim 1, comprises:
the plurality of sensors comprises a plurality of stethoscope placement sensors;
the plurality of stethoscope placement sensors being positioned within a torso of the mannequin housing; and
each of the plurality of stethoscope placement sensors being positioned at a corresponding respiratory site of the mannequin housing.

6. The audio and video enhanced patient simulating mannequin, as claimed in claim 1, comprises:
a mouth opening;
a throat tube;
the plurality of sensors comprises a plurality of intubation positioning sensors;
the mouth opening traversing into the head of the mannequin housing;
the throat tube being positioned within a neck of the mannequin housing;
the mouth opening being coupled with the throat tube; and
the plurality of intubation positioning sensors being adjacently positioned about the mouth opening and along the throat tube.

7. The audio and video enhanced patient simulating mannequin, as claimed in claim 1, comprises:
a plurality of anatomical actuators;
the plurality of anatomical actuators being internally mounted within the mannequin housing; and
the plurality of anatomical actuators being electronically connected to the CPU.

8. The audio and video enhanced patient simulating mannequin, as claimed in claim 7, comprises:
the plurality of anatomical actuators comprises a plurality of pulsing actuators; and
each of the plurality of pulsing actuators being positioned at a corresponding arterial pulse site of the mannequin housing.

9. The audio and video enhanced patient simulating mannequin, as claimed in claim 7, comprises:
the plurality of anatomical actuators comprises a pair of actuatable lungs; and
the pair of actuatable lungs being positioned within a torso of the mannequin housing.

10. The audio and video enhanced patient simulating mannequin, as claimed in claim 9, comprises:
each of the pair of actuatable lungs comprises an inflatable air bladder, a pressure release valve, and an air compressor;
the pressure release valve being adjacently connected to the inflatable air bladder;
the air compressor being adjacently connected to the inflatable air bladder;
the air compressor being in fluid communication with the pressure release valve through the inflatable air bladder; and
the pressure release valve and the air compressor being electronically connected to the CPU.

11. The audio and video enhanced patient simulating mannequin, as claimed in claim 1, comprises:
a plurality of permeable membranes;
the plurality of sensors comprises a plurality of positional sensors;
the plurality of permeable membranes being externally integrated into the mannequin housing;
the plurality of positional sensors being mounted within the mannequin housing; and
each of the plurality of positional sensors being adjacently positioned to a corresponding permeable membrane of the plurality of permeable membranes.

12. The audio and video enhanced patient simulating mannequin, as claimed in claim 1, comprises:
at least one external computing device; and
the CPU being communicatively coupled with the at least one external computing device.

13. The audio and video enhanced patient simulating mannequin, as claimed in claim 1, comprises:
a wireless transceiver;
the wireless transceiver being mounted within the mannequin housing; and
the wireless transceiver being electronically connected to the CPU.
